(19) United States
(12) Patent Application Publication
(10) Pub. No.: US 2020/0130153 A1
(43) Pub. Date: Apr. 30, 2020

(54) IMPACT ELECTRICAL TOOL

(71) Applicant: Panasonic Intellectual Property Management Co., Ltd., Osaka (JP)

(72) Inventor: Fumiiki YONEDA, Osaka (JP)

(21) Appl. No.: 16/619,554

(22) PCT Filed: Apr. 17, 2018
(86) PCT No.: PCT/JP2018/015812

§ 371 Date: Dec. 5, 2019

(30) Foreign Application Priority Data
Jun. 16, 2017 (JP) 2017-118969

(51) Int. Cl. B25B 23/147; B25B 21/02

(52) U.S. Cl. CPC B25B 23/1475; B25B 21/02

(57) ABSTRACT

An impact electric power tool is provided a motor; a striking mechanism connected to the motor; and a controller configured to control an operation of the motor. The controller includes one of a speed controller and a current controller that maintains a constant rotation speed of the motor by compensating for periodic fluctuations in load torque of the motor, where the fluctuations are caused due to the striking mechanism. The speed controller or the current controller includes a repetitive compensator or a resonant filter that compensates for the fluctuations in load torque of the motor to obtain a frequency or a cycle of the periodic fluctuations in load torque of the motor, which is caused due to the striking mechanism.

### TECHNICAL FIELD

The present disclosure relates to an impact electric power tool which includes a motor controller for controlling a motor, for example.

### BACKGROUND ART

There has been widely used in recent years an impact electric power tool as a tightening tool capable of converting rotations of a motor into hammering strikes to perform a tightening operation using a strong impact force generated by the strikes. This type of impact electric power tool is characterized by a smaller size, higher efficiency, a high torque, a lower reaction force, a smaller burden on a worker, and other characteristics in comparison with a conventional rotary tool using only a speed reducer.

However, problems such as noise, vibrations, cooperative control for a striking mechanism and the motor are still arising. For example, as an example of a method for solving the above problems, Patent Document 1 proposes a method that detects a minimal value of a motor rotation speed or a maximal value of a current and changes a PWM duty, while Patent Document 2 proposes a method that detects an impact based on rotations of a motor and reduces supply of electric power to the motor.

Moreover, for example, Patent Document 3 discloses an impact electric power tool which cuts wasted electric power consumed for maintaining rotations of an impact, and also generates a high impact striking force.

### PRIOR ART DOCUMENTS

### Patent Documents

[Patent Document 1] Japanese patent publication No. JP5115904B2

[Patent Document 2] Japanese patent publication No. JP4484447B2

[Patent Document 3] Japanese patent publication No. JP3791229B2

[Patent Document 4] Japanese patent publication No. JP4480696B2

[Patent Document 5] Japanese patent publication No. JP4198162B2

### SUMMARY OF THE INVENTION

### Problems to be Solved by the Invention

However, in cases of the methods of Patent Documents 1 to 3, the rotation speed of the motor and the current suddenly change when a load torque suddenly varies by seating, penetration, or for other reasons. In this case, such problems as instability of motor control and the striking operation itself, and step out and stop of the motor, and damage of the striking mechanism as a result of malfunction of the control may be caused.

An object of the present disclosure is to solve the aforementioned problems, providing an impact electric power tool capable of stabilizing a rotation speed of a motor and achieving more effective striking and a stable tightening torque under cooperative control over the motor and a striking mechanism to prevent step out of the motor and damage to the striking mechanism.

### Means for Solving the Problems

According to one aspect of the disclosure, there is provided an impact electric power tool including a motor; a striking mechanism connected to the motor; and a controller configured to control an operation of the motor. The controller includes one of a speed controller and a current controller that maintains a constant rotation speed of the motor by compensating for periodic fluctuations in load torque of the motor, where the fluctuations is caused due to the striking mechanism.

### Effect of the Invention

The impact electric power tool according to the present disclosure is capable of compensating for the periodic fluctuations in load torque of the motor, where the fluctuations is unique to the impact electric power tool and caused due to the striking mechanism. Therefore, the impact electric power tool is capable of further stabilizing the rotation speed of the motor. Accordingly, a more effective strike and a more stable tightening torque can be generated, and also step out of the motor and damage to the striking mechanism can be prevented.

### BRIEF DESCRIPTION OF THE DRAWINGS

FIG. 1 is a block diagram showing a configuration example of an impact electric power tool according to a first embodiment of the present disclosure.

FIG. 2 is an analysis model diagram of a motor 1 of the impact electric power tool of FIG. 1.

FIG. 3 is a block diagram showing a detailed configuration example of the impact electric power tool of FIG. 1.

FIG. 4 is a block diagram showing a detailed configuration example of a speed controller 17 of FIG. 3.

FIG. 5 is a block diagram showing a detailed configuration example of a speed controller 17A according to a modified embodiment.

FIG. 6 is a graph for explaining a principle concerning reduction of speed fluctuations by the speed controller 17A of FIG. 5.

FIG. 7 is a graph showing frequency characteristics of an amplitude and a phase of a resonant filter 54 of FIG. 5.

FIG. 8 is a block diagram showing a detailed configuration example of a current controller 15 according to another embodiment.

FIG. 9 is a block diagram showing a detailed configuration example of a current controller 15A according to a further embodiment.

### MODE FOR CARRYING OUT THE INVENTION

Embodiments according to the present disclosure will be hereinafter specifically described with reference to the drawings. In each of the drawings to be referred to, identical parts are given identical reference numbers, and description of the identical parts is not repeated in principle. In addition, in each of the drawings to be referred to, matters given identical symbols (for example, θ, ω) are identical matters. In addition, a state quantity and the like may be represented only by symbols for simplifying the description. More specifically, an “estimated motor speed ωₑ” may be simply referred to as a “ωₑ”, for example, but both the cases refer to an identical matter.

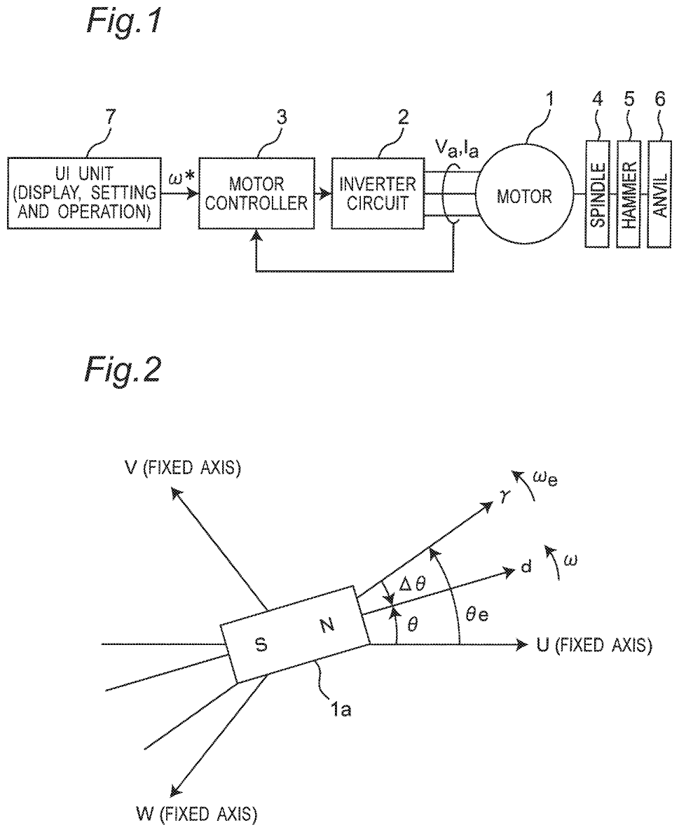

FIG. 1 is a block diagram showing a configuration example of an impact electric power tool according to a first embodiment of the present disclosure. The impact electric power tool according to the first embodiment of FIG. 1 is an impact electric driver or an impact electric wrench, for example, and includes a motor 1, an inverter circuit 2, a motor controller 3, a spindle 4, a hammer 5, an anvil 6, and a user interface unit (UI unit) 7.

The motor 1 of FIG. 1 is configured to include a three-phase permanent magnet synchronous motor, which includes a permanent magnet on a rotor (not shown), and an armature winding on a stator (not shown), for example. It is assumed that the terms of the armature winding and the rotor in the following description are abbreviations of the armature winding provided on the stator of the motor 1 and the rotor of the motor 1, respectively. The motor 1 is a salient pole machine (motor having saliency) represented by an interior permanent magnet synchronous motor (IPMSM), for example, but may be a non-salient pole machine. A rotation shaft of the motor 1 in this case is connected to the hammer 5 via the spindle 4. The hammer 5 rotates in accordance with rotations of the spindle 4 rotated by the motor 1. Subsequently, the anvil 6 is struck by the hammer 5 rotated as above, and an impact strike generated by the hammer 5 is transmitted to a processing target material such as a driver bit via the anvil 6. Accordingly, the spindle 4, the hammer 5, and the anvil 6 configures a striking mechanism.

The inverter circuit 2 supplies a three-phase AC voltage constituted of a U phase, a V phase, and a W phase to the armature winding of the motor 1 in accordance with a rotor position of the motor 1. It is assumed that a voltage supplied to the armature winding of the motor 1 is a motor voltage (armature voltage) Vₐ, and a current supplied to the armature winding of the motor 1 from the inverter circuit 2 is a motor current (armature current) Iₐ.

For example, the motor controller 3 has a position sensorless control function which estimates a rotor position, a rotation speed and the like of the motor 1 based on the motor current Iₐ, and outputs a signal for rotating the motor 1 at a desired rotation speed to the inverter circuit 2. It is noted that the desired rotation speed is preset by the user interface unit 7, and is outputted to the motor controller 3 as a motor speed command value ω* in conjunction with a trigger switch (not shown) operated by a user.

FIG. 2 is an analysis model diagram of the motor 1 of the impact electric power tool of FIG. 1. FIG. 2 shows U-phase, V-phase, and W-phase armature winding fixed axes. In a rotation coordinate system which rotates at a speed identical to a speed of a magnetic flux generated by a permanent magnet 1a constituting the rotor of the motor 1, it is assumed that a d-axis represents a direction of a magnetic flux generated by the permanent magnet 1a, and that a γ-axis represents an estimation axis under control in correspondence with the d axis. While not shown in the figure, a q-axis is defined in the phase advanced by an electrical angle of 90 degrees from the d-axis, and a δ-axis as an estimation axis is defined in the phase advanced by an electrical angle of 90 degrees from the γ-axis. Coordinate axes of the rotation coordinate system which designates the d-axis and the q-axis as coordinate axes are referred to as d-q axes (real axes). The rotation coordinate system under control (estimation rotation coordinate system) is a coordinate system which designates the γ-axis and the δ-axis as coordinate axes. These coordinate axes are referred to as γ-δ axes.

The d-q axes are rotating. A rotation speed of the d-q axes (i.e., rotation speed of the rotor of the motor 1) is referred to as an actual motor speed ω. The γ-δ axes are also rotating. A rotation speed of the γ-δ axes is referred to as an estimated motor speed ωₑ. In addition, in the d-q axes rotating at a certain moment, a phase of the d-axis is represented by θ (actual rotor position θ) with reference to the U-phase armature winding fixed axis. Similarly, in the γ-δ axes rotating at a certain moment, a phase of the γ-axis is represented by θₑ (estimated rotor position θₑ) with reference to the U-phase armature winding fixed axis. In this case, an axis error Δθ between the d-axis and the γ-axis (axis error Δθ between the d-q axes and the γ-δ axes) is expressed as Δθ=θ−θₑ. It is noted that each of parameters ω*, ω, and ωₑ is represented by an electrical angular speed.

In the following description, a γ-axis component, a δ-axis component, a d-axis component, and a q-axis component of the motor voltage Vₐ are represented by a γ-axis voltage v_{γ}, a δ-axis voltage v_{δ}, a d-axis voltage v_{d}, and a q-axis voltage v_{q}, respectively. A γ-axis component, a δ-axis component, a d-axis component, and a q-axis component of the motor current Iₐ are represented by a γ-axis current i_{γ}, a δ-axis current i_{δ}, a d-axis current i_{d}, and a q-axis current i_{q}, respectively.

In addition, Rₐ is a motor resistor (resistance value of the armature winding of the motor 1), L_{d} and L_{q} are d-axis inductance (d-axis component of inductance of the armature winding of the motor 1), and q-axis inductance (q-axis component of inductance of the armature winding of the motor 1), and Φₐ is an armature interlinkage magnetic flux generated by the permanent magnet 1a. It is noted that the values L_{d}, L_{q}, Rₐ, and Φₐ are values determined during manufacture of a motor drive system for the impact electric power tool. These values are used during calculation by the motor controller 3.

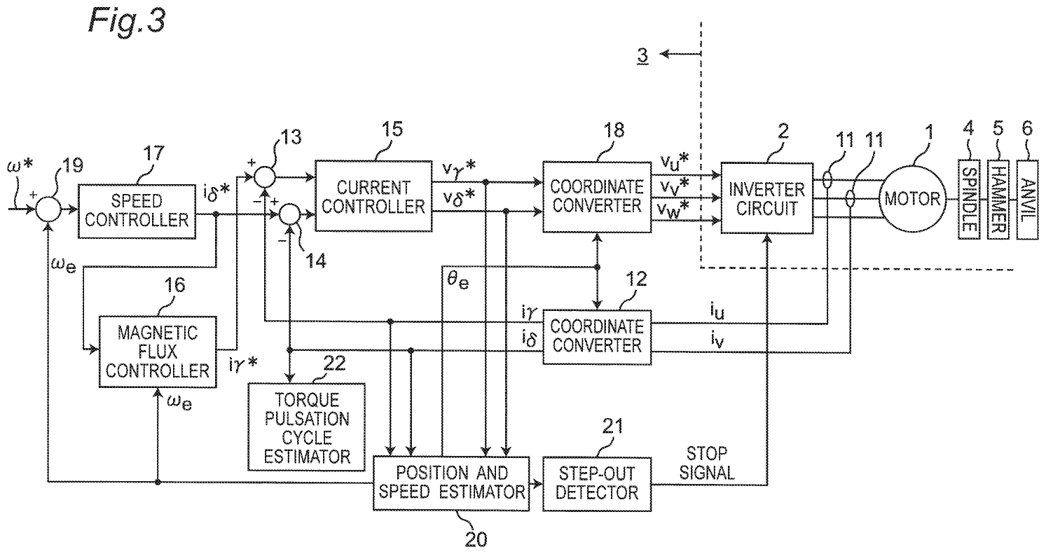

FIG. 3 is a block diagram showing a detailed configuration example of the impact electric power tool of FIG. 1. Referring to FIG. 3, the motor controller 3 includes current detectors 11, a coordinate transformer 12, a subtractor 13, a subtractor 14, a current controller 15, a magnetic flux controller 16, a speed controller 17, a coordinate transformer 18, a subtractor 19, a position and speed estimator 20, a step-out detector 21, and a torque pulsation cycle estimator 22.

The current detectors 11 are each composed of a Hall element, for example, and detect a U-phase current iᵤ (current flowing in the U-phase armature winding), and a V-phase current iᵥ (current flowing in the V-phase armature winding) of the motor current Iₐ supplied from the inverter circuit 2 to the motor 1. It is noted that these currents may be detected by various existing current detection systems each incorporating a shunt resistor or the like in the inverter circuit 2. The coordinate transformer 12 receives detection results of the U-phase current iᵤ and V-phase current iᵥ from the current detector 11, and transforms the detection results into a γ-axis current iᵥ (current controlling the magnetic flux of the motor) and a δ-axis current i_{δ} (current directly proportional to supplied torque of the motor and directly contributing to generation of rotation torque of the motor) using the following Equation (1) based on the estimated rotor position θₑ received from the position and speed estimator 20.

$$[ \begin{matrix}{i}_{γ} \\ {i}_{δ}\end{matrix} ] = \sqrt{2} [ \begin{matrix}sin ( {θ}_{e} + π / 3 ) & sin {θ}_{e} \\ cos ( {θ}_{e} + π / 3 ) & cos {θ}_{e}\end{matrix} ] [ \begin{matrix}{i}_{u} \\ {i}_{v}\end{matrix} ] \qquad ( 1 )$$

The position and speed estimator 20 estimates and outputs the estimated rotor position θₑ and the estimated motor speed ωₑ. The estimated rotor position θₑ and the estimated motor speed ωₑ may be estimated using a method disclosed in Patent Document 4, for example.

The torque pulsation cycle estimator 22 identifies a frequency or a cycle of periodic fluctuations in load torque of the motor, which are caused due to the striking mechanism of the impact electric power tool, based on a frequency or a cycle of the pulsation component of the δ-axis current i_{δ}, and outputs the identified frequency or cycle to a repetitive compensator 53 and a resonant filter 54 described below.

The δ-axis current is a current directly proportional to a supply torque of the motor, and directly contributing to generation of a rotation torque of the motor. Accordingly, the frequency or the cycle of the periodic fluctuations in load torque of the motor which is caused due to the striking mechanism of the impact electric power tool can be identified by detecting the frequency or cycle of the pulsation component.

It is noted that the frequency or the cycle of the pulsation component of the δ-axis current is detected by filtering the δ-axis current using a band-pass filter or the like, subsequently detecting a zero cross of a corresponding signal, and measuring a time interval or the like of the zero-cross signal, for example.

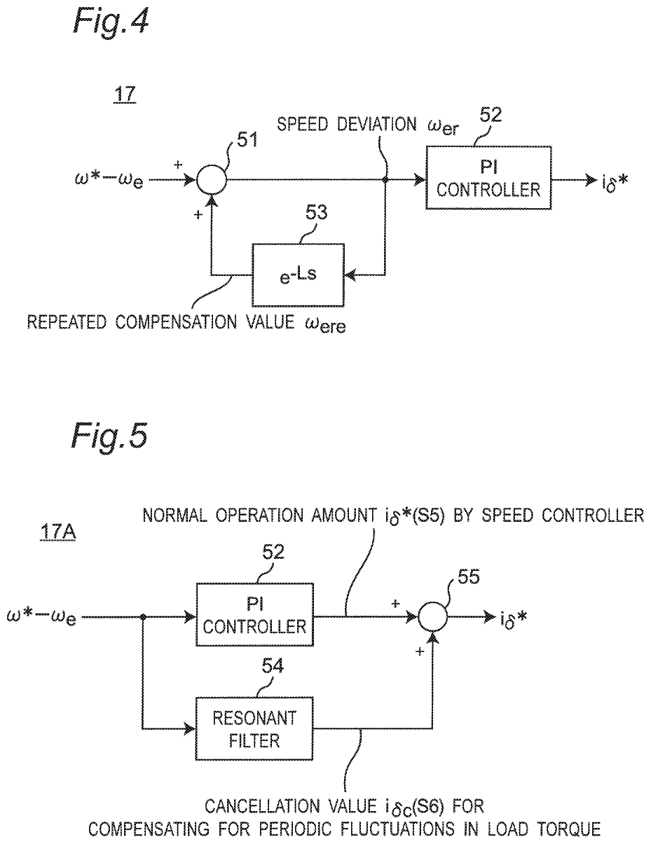

The subtractor 19 subtracts the estimated motor speed ωₑ given by the position and speed estimator 20 from the motor speed command value ω* given by the user interface unit 7, and outputs a speed error (ω*−ωₑ) as a subtraction result. The speed controller 17 generates a δ-axis current command value i_{δ}* using a proportional integral (PI) controller 52 and the repetitive compensator 53 (FIG. 4), for example, based on the subtraction result (ω*−ωₑ) of the subtractor 19. The δ-axis current command value i_{δ}* represents a current value which is to be followed by the δ-axis current is as the δ-axis component of the motor current Iₐ. The magnetic flux controller 16 outputs a γ-axis current command value i_{γ}. In this case, the δ-axis current command value i_{δ}* and the estimated motor speed we are referred to as necessary. The γ-axis current command value i_{γ}* represents a current value which is to be followed by the γ-axis current i_{γ} as the γ-axis component of the motor current Iₐ.

The subtractor 13 subtracts the γ-axis current i_{γ} outputted by the coordinate transformer 12 from the γ-axis current command value i_{γ}* outputted by the magnetic flux controller 16 to calculate a current error (i_{γ}*−i_{γ}) as a subtraction result. The subtractor 14 subtracts the δ-axis current is outputted by the coordinate transformer 12 from the δ-axis current command value i_{δ}* outputted by the speed controller 17 to calculate a current error (i_{δ}*−i_{δ}) as a subtraction result.

The current controller 15 receives the respective current errors calculated by the subtractors 13 and 14, and calculates and outputs the γ-axis voltage command value v_{γ}* and the δ-axis voltage command value v_{δ}* such that the γ-axis current i_{γ} follows the γ-axis current command value i_{γ}*, and that the δ-axis current i_{δ} follows the δ-axis current command value i_{δ}*.

The coordinate transformer 18 performs inverse transform of the γ-axis voltage command value v_{γ}* and the δ-axis voltage command value v_{δ}* based on the estimated rotor position θₑ given from the position and speed estimator 20, generates a three-phase voltage command value consisting of a U-phase voltage command value vᵤ*, a V-phase voltage command value vᵥ* and a W-phase voltage command value v_{w}* representing the U-phase component, V-phase component, and W-phase component of the motor voltage Vₐ, and outputs the generated three-phase command value to the inverter circuit 2. The following Equation (2) is used for this inverse transform.

$$\begin{matrix}[ \begin{matrix}{v}_{u}^{*} \\ {v}_{v}^{*}\end{matrix} ] = \sqrt{\frac{2}{3}} [ \begin{matrix}cos {θ}_{e} & - sin {θ}_{e} \\ cos ( {θ}_{e} - 2 π / 3 ) & - sin ( {θ}_{e} - 2 π / 3 )\end{matrix} ] [ \begin{matrix}{v}_{γ}^{*} \\ {v}_{δ}^{*}\end{matrix} ] & ( 2 ) \\ {v}_{w}^{*} = - ( {v}_{u}^{*} + {v}_{v}^{*} ) & \end{matrix}$$

The inverter circuit 2 generates a signal having a pulse width modulated based on the three-phase voltage command value (vᵤ*, vᵥ*, and v_{w}*) representing a voltage to be applied to the motor 1, and supplies the motor current Iₐ corresponding to the three-phase voltage command value (vᵤ*, vᵥ*, and v_{w}*) to the armature winding of the motor 1 to drive the motor 1.

The step-out detector 21 estimates a rotation speed of the rotor using an estimation system different from the estimation system of the rotation speed of the rotor adopted by the position and speed estimator 20 (for example, see Patent Document 5). When a large difference is recognized, the motor 1 is forcibly stopped on an assumption of step out.

FIG. 4 is a block diagram showing a detailed configuration example of the speed controller 17 of FIG. 3. The speed controller 17 of FIG. 4 includes an adder 51, the PI controller 52, and the repetitive compensator 53.

As described in the section on prior art, the periodic fluctuations in load torque which is caused due to the striking mechanism destabilize motor speed control and current control, and finally affect striking. Accordingly, how to compensate in advance for the delay of speed control caused by the periodic fluctuations in torque is important. According to the present embodiment, the speed controller 17 is particularly characterized by compensating for the fluctuations in load torque of the motor by generating a repetitive compensation signal having a repetitive compensation value ωₑ based on a speed deviation one cycle before in correspondence with the fluctuations in load torque, and adding the repetitive compensation signal to a speed deviation (ω*−ωₑ) between the speed command value and the estimated speed value of the motor 1.

The adder 51 of FIG. 4 generates a repetitive compensation signal having the repetitive compensation value ω_{erc} received from the repetitive compensator 53 for the speed deviation (ω*−ωₑ) between the speed command value and the estimated speed value of the motor 1, and outputs the generated repetitive compensation signal to the PI controller 52 and the repetitive compensator 53. The PI controller 52 generates the δ-axis current command value i_{δ}* using a known proportional integral (PI) control method, for example, based on the sum of the speed deviation (ω*−ωₑ) and the repetitive compensation value ω_{erc}, and outputs the generated δ-axis current command value i_{δ}*. In addition, the repetitive compensator 53 generates a repetitive compensation signal having the repetitive compensation value ω_{erc} using the following Equation (3), and outputs the generated repetitive compensation signal to the adder 51.

ω_{erc}=ωₑᵣ×e^{-La} (3)

In this case, L is a cycle of torque pulsation, s is a Laplace operator, and e is a base of a natural logarithm.

For example, the repetitive compensation control is an effective control system for following periodic target signals appearing in a repetitive operation of a robot, and for removing periodic disturbances synchronized with a rotation speed generated in a rotation system such as a motor. The basic idea is an “internal model principle” required for a servo system, which is a servo system having a model of a generator of periodic signals within a feedback. The feature of the repetitive compensation control is utilization of a deviation signal one cycle before, and corresponds to a type of learning control system which reduces speed deviations by continuing repetitive operations.

According to the PI control method using the repetitive compensation of FIG. 4, the rotation speed of the motor 1 is more stabilized. Accordingly, effective striking and stable generation of a tightening torque are achievable. In addition, step out of the motor 1, damage to the striking mechanism and the like can be prevented.

According to the present embodiment described above, the speed controller 17 is particularly capable of compensating for the fluctuations in load torque of the motor 1 by generating the repetitive compensation signal having the repetitive compensation value ω_{erc} based on the deviation signal of the load torque generated one cycle before and having the speed deviation ωₑᵣ corresponding to the deviation of the load torque, and adding the repetitive compensation signal to the speed deviation (ω*−ωₑ) between the speed command value and the estimated speed value of the motor 1.

In this case, a constant rotation speed of the motor can be dynamically maintained even when the load torque of the motor is periodically pulsated by the striking mechanism. Accordingly, more effective striking and generation of a more stable tightening torque of the impact electric power tool are achievable, for example. In addition, step out of the motor and damage to the striking mechanism, such as collision between a barrier and the spindle 4 having excessively retreated and breakage by the collision, are avoidable.

FIG. 5 is a block diagram showing a detailed configuration example of a speed controller 17A according to a modified embodiment provided in place of the speed controller 17 of FIG. 4. In FIG. 5, the speed controller 17A includes the PI controller 52, the resonant filter 54, and an adder 55.

Referring to FIG. 5, the PI controller 52 generates a normal δ-axis current command value i_{δ}* (S5) based on the above-mentioned speed deviation (ω*−ωₑ) using a known proportional integral (PI) control method, for example, and outputs the generated δ-axis current command value i_{δ}* to the adder 55. The resonant filter 54 generates a cancel value i_{qc} (S6) which compensates for periodic pulsation of the load torque based on the above-mentioned speed deviation (ω*−ωₑ) using the following Equation (4), for example, and outputs the cancel value i_{qc} (S6) to the adder 55. The adder 55 adds the cancel value ii to the normal δ-axis current command value i_{δ}*, and outputs the added value to the subsequent stage as an operation amount of the speed controller 17A.

i_{qc}=(ω*−ωₑ)×F(ωᵣ) (4)

In this case, F(ωᵣ) is a transfer function of the resonant filter 54, and is expressed by the following Equation (11).

$$F ( {ω}_{r} ) = \frac{{b}_{0}}{{s}^{2} + 2 ζ {ω}_{r} + {ω}_{r}^{2}} \qquad ( 11 )$$

In this case, ωᵣ is an angular speed (frequency) of torque pulsation, each of b₀ and ξ is a predetermined constant, and s is a Laplace operator.

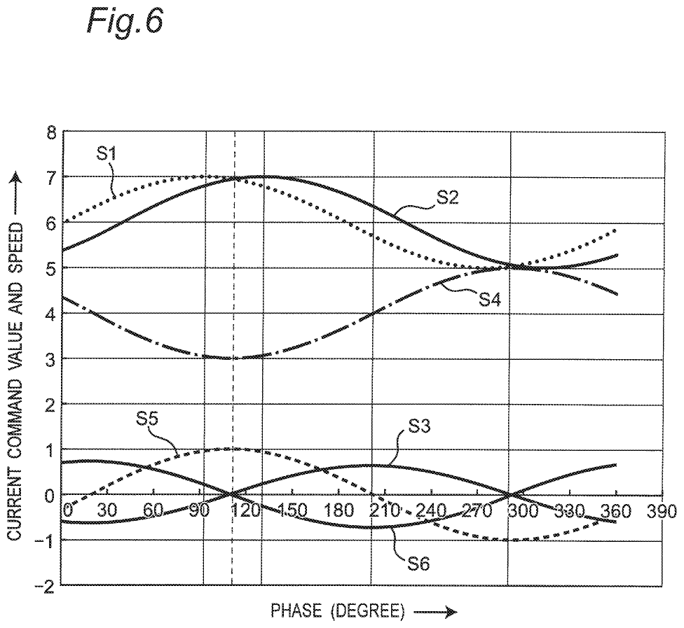

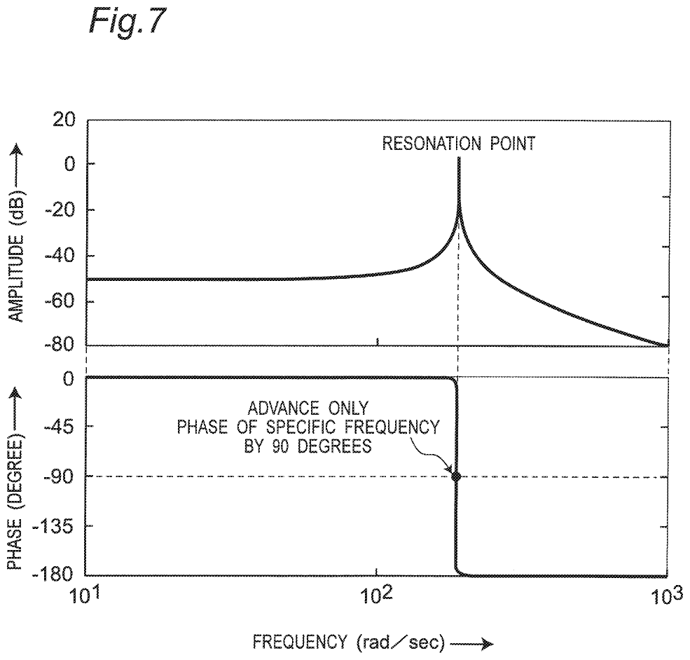

FIG. 6 is a graph for explaining a principle concerning reduction of speed fluctuations by the speed controller 17A of FIG. 5, while FIG. 7 is a graph showing frequency characteristics of an amplitude and a phase of the resonant filter 54 of FIG. 5.

In the diagram of the principle for reducing the speed fluctuations as shown in FIG. 6, each of an ideal current command value S1 and an actual current command value S2 has current command value deviations S3 caused by a control delay or for other reasons. The speed fluctuations S4 are caused by the current command value deviations S3. A cancel signal S6 for canceling the current command value deviations S3 needs to be generated to reduce the speed fluctuations S4.

In this case, a relationship between speed deviations 55 from a target speed and a cancel signal S6 is established such that the phase of the cancel signal S6 is advanced by 90 degrees from the speed deviations S5 from the target speed. According to this method, the resonant filter 54 having a transfer function F(ωᵣ) of Equation (11) described above is used to generate the cancel signal S6 advanced by 90 degrees.

According to the frequency characteristics of the transfer function F(ωᵣ), one resonant point is exhibited as shown in FIG. 7. In this case, only the frequency component at this resonant point is extracted, and only the phase of the extracted frequency component is advanced by 90 degrees to generate a waveform having the phase thus advanced. Referring to FIG. 5, the speed deviation (ω*−ωₑ) is inputted to the resonant filter 54, and the cancel value i_{qc} is outputted from the resonant filter 54. The cancel value i_{qc} acts in such a direction as to eliminate the speed deviations. Accordingly, the rotation speed of the motor 1 is stabilized.

According to the modified embodiment configured as described above, the speed controller 17A compensates for periodic fluctuations in load torque of the motor by extracting a component of a predetermined resonant frequency from the speed deviation between the speed command value and the estimated speed value of the motor 1, and adding the resonant frequency component to an operation amount of the speed controller 17A as a cancel value for compensating for periodic fluctuations of the load torque.

In this case, a constant rotation speed of the motor can be dynamically maintained even when the load torque of the motor is periodically pulsated by the striking mechanism. Accordingly, more effective striking and generation of a more stable tightening torque of the impact electric power tool are achievable, for example. In addition, step out of the motor and damage to the striking mechanism, such as collision between a barrier and the spindle 4 having excessively retreated and breakage by the collision, are avoidable.

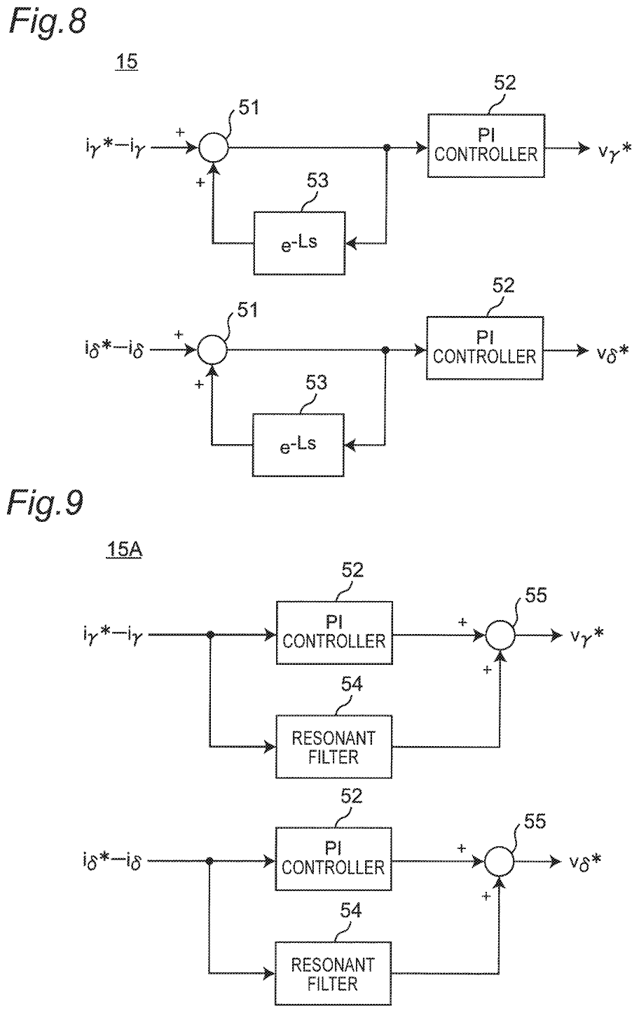

FIG. 8 is a block diagram showing a detailed configuration example of the current controller 15 according to another embodiment. The current controller 15 of FIG. 8 includes the adder 51, the PI controller 52, and the repetitive compensator 53.

According to the present embodiment, the current controller 15 is characterized by including a repetitive compensator which compensates for the fluctuations in load torque of the motor by generating a repetitive compensation value based on a current deviation of a load torque one cycle before, and adding the repetitive compensation value to a current deviation between a current command value and an estimated current value of the motor.

In particular, the current controller 15 of the present embodiment is capable of compensating for the fluctuations in load torque of the motor 1 by generating a repetitive compensation signal having a repetitive compensation value based on a current deviation signal generated one cycle before and having current deviations corresponding to fluctuations in the load torque, and adding the repetitive compensation signal to the current deviation between the current command value and the estimated current value of the motor 1.

In this case, a constant rotation speed of the motor can be dynamically maintained even when the load torque of the motor is periodically pulsated by the striking mechanism. Accordingly, more effective striking and generation of a more stable tightening torque of the impact electric power tool are achievable, for example. In addition, step out of the motor and damage to the striking mechanism, such as collision between a barrier and the spindle 4 having excessively retreated and breakage by the collision, are avoidable.

FIG. 9 is a block diagram showing a detailed configuration example of a current controller 15A of the current controller 15 according to a modified embodiment of a further embodiment. Referring to FIG. 9, the current controller 15A includes the PI controller 52, the resonant filter 54, and the adder 55.

According to the present embodiment, the current controller 15A is characterized by including a resonant filter for compensating for the fluctuations in load torque of the motor by extracting a component of a predetermined resonant frequency from a current deviation between a current command value and an estimated current value of the motor, and adding the resonant frequency component to an operation amount of the current controller as a cancel value for compensating for the periodic fluctuations in load torque.

The current controller 15A of the present embodiment is capable of compensating for the fluctuations in load torque of the motor by extracting the component of the predetermined resonant frequency from the speed deviation between the speed command value and the estimated speed value of the motor, and adding the resonant frequency component to the operation amount of the current controller 15A as a cancel value for compensating for the periodic fluctuations in load torque.

In this case, a constant rotation speed of the motor can be dynamically maintained even when the load torque of the motor is periodically pulsated by the striking mechanism. Accordingly, more effective striking and generation of a more stable tightening torque of the impact electric power tool are achievable, for example. In addition, step out of the motor and damage to the striking mechanism, such as collision between a barrier and the spindle 4 having excessively retreated and breakage by the collision, are avoidable.

### DESCRIPTION OF REFERENCE CHARACTERS

1: MOTOR
2: INVERTER CIRCUIT
3: MOTOR CONTROLLER
4: SPINDLE
5: HAMMER
6: ANVIL
7: USER INTERFACE UNIT (UI UNIT)
11: CURRENT DETECTOR
12: COORDINATE TRANSFORMER
13, 14: SUBTRACTOR
15: CURRENT CONTROLLER
16: MAGNETIC FLUX CONTROLLER
17, 17A: SPEED CONTROLLER
18: COORDINATE TRANSFORMER
19: SUBTRACTOR
20: POSITION AND SPEED ESTIMATOR
21: STEP-OUT DETECTOR
22: TORQUE PULSATION CYCLE ESTIMATOR
51: ADDER
52: PI CONTROLLER
53: REPETITIVE COMPENSATOR
54: RESONANT FILTER
55: ADDER

1. An impact electric power tool comprising:
a motor;
a striking mechanism connected to the motor; and
a controller configured to control an operation of the motor,
wherein the controller includes one of a speed controller and a current controller that maintains a constant rotation speed of the motor by compensating for periodic fluctuations in load torque of the motor, the fluctuations being caused due to the striking mechanism.

2. The impact electric power tool as claimed in claim 1,
wherein the speed controller includes a repetitive compensator that compensates for the fluctuations in load torque of the motor, by generating a repetitive compensation value based on a speed deviation of a load torque one cycle before, and adding the repetition compensation value to a speed deviation between a speed command value and an estimated speed value of the motor.

3. The impact electric power tool as claimed in claim 1,
wherein the speed controller includes a resonant filter that compensates for the fluctuations in load torque of the motor, by extracting a component of a predetermined resonant frequency from a speed deviation between a speed command value and an estimated speed value of the motor, and adding the extracted component of the resonant frequency to an operation amount of the speed controller as a cancel value for compensating for the periodic fluctuations in load torque of the motor.

4. The impact electric power tool as claimed in claim 1,
wherein the current controller includes a repetitive compensator that compensates for the fluctuations in load torque of the motor, by generating a repetitive compensation value based on a current deviation of a load torque one cycle before, and adding the repetition compensation value to a current deviation between a current command value and an estimated current value of the motor.

5. The impact electric power tool as claimed in claim 1,
wherein the current controller includes a resonant filter that compensates for the fluctuations in load torque of the motor, by extracting a component of a predetermined resonant frequency from a current deviation between a current command value and an estimated current value of the motor, and adding the extracted component of the resonant frequency to an operation amount of the current controller as a cancel value for compensating for the periodic fluctuations in load torque of the motor.

6. The impact electric power tool as claimed in claim 1,
wherein one of a frequency and a cycle of the periodic fluctuations in load torque of the motor, which is caused due to the striking mechanism is obtained from one of a frequency and a cycle of a pulsation component of a current that contributes to torque generation of the motor.
